(19) United States
(12) Patent Application Publication
(10) Pub. No.: US 2005/0025390 A1
(43) Pub. Date: Feb. 3, 2005

(54) Information processing apparatus and method

(76) Inventor: Osamu Tsujii, Tochigi (JP)

Correspondence Address: MORGAN & FINNEGAN, L.L.P., 3 WORLD FINANCIAL CENTER, NEW YORK, NY, 10281-2101, US

(21) Appl. No.: 10/843,115

(22) Filed: May 11, 2004

(30) Foreign Application Priority Data
May 12, 2003 (JP) 2003-133533

(51) Int. Cl. B41J 1/00; G06K 1/00

(52) U.S. Cl. 382/305; 705/2; 600/300

(57) ABSTRACT

This invention provides an information processing apparatus and method, which can suitably create an electronic chart in which link information about a diagnosed medical image, image processing log information, and a diagnostic report are recorded in correspondence with each other. An image search unit (103) searches an image storage unit (104) storing medical image data for image data. An image processing unit (109) executes image processing. An image display unit (110) displays the image data. At this time, an image link information recording unit (105) records image link information (107) to the image data in the image storage unit (104). An image processing/display procedure recording unit (111) records processing log information (112) for the image data. A report input unit (101) inputs report information (113) related to the displayed image data. A diagnostic report output unit (114) outputs diagnostic report information containing the image link information (107), processing log information (112), and report information (113).

### FIELD OF THE INVENTION

The present invention-relates to an information processing technique for displaying an electronic chart formed by synthesizing a medical image and a diagnostic report.

### BACKGROUND OF THE INVENTION

Recently, doctors in hospitals and the like can display medical images by using a PACS (Picture Archiving/Communicating System) and diagnose the symptoms of patients. In diagnosis using a computer, doctors are supposed to create an appropriate image for diagnosis by changing various kinds of image processing parameters including the magnification of an image to be diagnosed and window information for displaying the image. Additionally, a diagnostic report based on diagnosis of the medical image is also electronically created as an electronic chart.

Generally, when a medical image such as an X-ray image or a CT image should be displayed on a monitor, a doctor sets parameters corresponding to the part to be observed to process the medical image so that the processed image is displayed. More specifically, in, for example, a hospital, medical images processed by using different parameters are simultaneously displayed on a plurality of monitors or sequentially displayed on one monitor. A doctor diagnoses the symptom of the patient by observing the plurality of images and creates an electronic chart. For a person who wants to refer to a thus created electronic chart later, it is preferable that the observed images can also be referred to.

Conventionally, a technique for recording a series of image processing procedures executed in an information processing apparatus is disclosed (e.g., patent reference 1: Japanese Patent Laid-Open No. 60-195674). In the information processing apparatus described in patent reference 1, an image display apparatus or an application system (e.g., a medical image-data communication system) using the image display apparatus is operated. Hence, a function of holding a series of input commands is used as a history function.

A technique related to an image display apparatus having a reading procedure storage/playback means capable of tracing procedures in the determination process in observing images and displaying main points is also disclosed (e.g., patent reference 2: Japanese Patent Laid-Open No. 6-000178). More specifically, as for the storage means in the image display apparatus described in patent reference 2, an image display information storage means in a procedure storage means stores a display apparatus and a display image in association with each other. A sorting information storage means makes an image displayed on the display apparatus and reference information referred to and displayed in association with that image correspond to each other and stores them as procedure information. An information processing information storage means stores parameters to change the display state of the display image as procedure information. An overlay information storage means stores overlay information as procedure information. A report information storage means makes report information input in association with the displayed image and that image correspond to each other and stores them as procedure information. On the other hand, in the playback means, a procedure information reading means reads out the stored procedure information. A first playback means displays selected procedure information. A second playback means selectively displays procedure information which is not selected by a procedure information discrimination means. Patent reference 2 discloses the image display apparatus having the above-described arrangement.

A technique that aims at making it possible to quickly create a correct and clear reading report without impeding the reading operation and, in creating the report, directly refer to and quote images which are being read is also disclosed (e.g., patent reference 3: Japanese Patent Laid-Open No. 9-198453). The technique described in patent reference 3 has the following arrangement. A medical image (displayed in an image display window) which is being read and is sequentially changed by editing based on reader's instructions is automatically stored in a memory in accordance with a timing using various instructions or operations executed by the reader during editing. The medical image itself or information necessary for playback of the medical image, including editing contents, is stored. In creating a reading report displayed in a report display window, the stored image and editing contents are used.

A technique for adding authentication data to an electronic chart to prevent any alteration is also disclosed (e.g., nonpatent reference 1: Transaction of the Institute of Image Information and Television Engineers (Vol. 55, No. 2, pp. 190-193, 2001)). The present conditions and problems of legal bases of digital images and electronic seals are presented in nonpatent reference 1.

However, to cause each doctor to store processed medical images in his/her computer for each information processing parameter, a storage device having an enormous memory capacity is necessary because one medical image should be observed by a plurality of doctors. Hence, this processing/recording method is not appropriate. More specifically, when an information processing result is stored in correspondence with each diagnostic situation, double recording of images or frequent rewrite of image headers occurs, and it is not efficient in the operation for image storage.

In addition, in the above-described conventional techniques, when one diagnostic report is created by using a plurality of images, one-to-one correspondence is impossible, and appropriate recording cannot be done. From the viewpoint of medical suits, it is necessary to play back details of a diagnostic situation without any change or record image access logs such as the type of image processing, images which have undergone the image processing, and the display time of each image for diagnosis.

### SUMMARY OF THE INVENTION

The present invention has been proposed to solve the conventional problems, and has as its objects to provide an information processing apparatus and method, which can suitably create an electronic chart in which link information about a diagnosed medical image, image processing log information, and a diagnostic report are recorded in correspondence with each other.

In order to achieve the above object, according to the present invention, there is provided an information processing apparatus characterized by comprising storage means for storing image data, search means for searches the storage means for the image data, image processing means for executing image processing for the image data searched by the search means, display means for displaying the image data which has undergone image processing by the image processing means, first acquisition means for acquiring diagnostic information related to the image data displayed by the display means, second acquisition means for acquiring link information to the image data stored in the storage means, third acquisition means for acquiring image processing information for the image data by the image processing means and output means for outputting diagnostic report information containing the link information, the image processing information, and the diagnostic information.

Furthermore, in order to achieve the above object, according to the present invention, there is provided an information processing method characterized by comprising a search step of searching a storage device storing image data for image data, a first acquisition step of acquiring link information to the image data stored in the storage device, an image processing step of executing image processing for the image data searched in the search step, a second acquisition step of acquiring image processing information for the image data in the image processing step, a display step of displaying the image data which has undergone image processing in the image processing step, a third acquisition step of acquiring diagnostic information related to the image data displayed in the display step and an output step of outputting diagnostic report information containing the link information, the image processing information, and the diagnostic information.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an information processing apparatus to create an electronic chart according to the first embodiment of the present invention;

FIG. 2 is a schematic view showing the arrangement of a user interface which implements an image operation input unit 102 of the information processing apparatus according to the first embodiment of the present invention;

FIG. 3 is a view showing the structure of diagnostic report information formed in the first embodiment;

FIG. 4 is a flowchart for explaining a diagnostic file formation sequence in the information processing apparatus according to the first embodiment of the present invention;

FIG. 5 is a block diagram showing the arrangement of an information processing apparatus to play back an image from the diagnostic report information according to the first embodiment of the present invention;

FIG. 6 is a view for explaining a process for adding a digital signature by using an information processing apparatus according to the second embodiment of the present invention; and

FIG. 7 is a view for explaining a collation process for checking whether alteration has been done in referring to a diagnostic report with a digital signature by using the information processing apparatus according to the second embodiment of the present invention.

### DETAILED DESCRIPTION OF THE PREFERRED EMBODIMENTS

An information processing apparatus according to an embodiment of the present invention will be described below in detail with reference to the accompanying drawings.

### First Embodiment

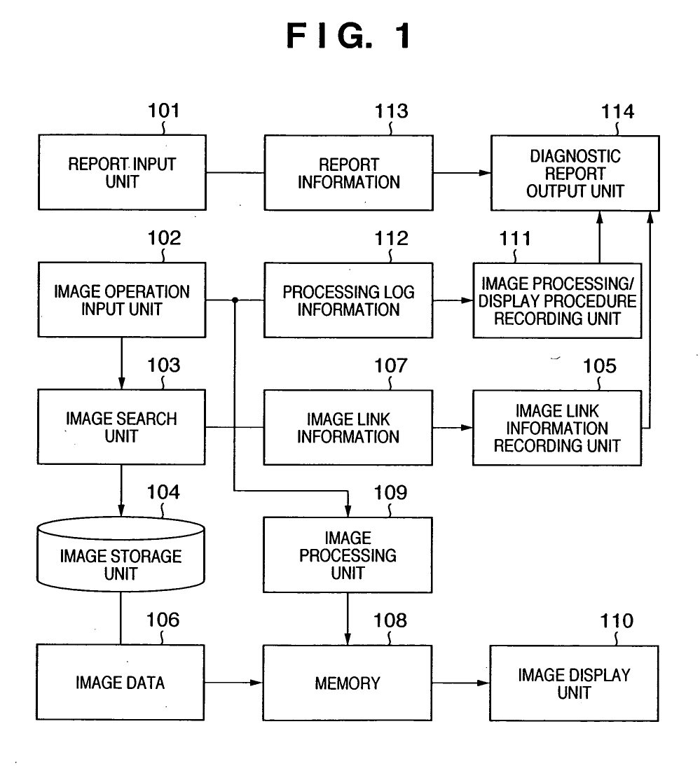

FIG. 1 is a block diagram showing the arrangement of an information processing apparatus to create an electronic chart according to the first embodiment of the present invention.

Referring to FIG. 1, a report input unit 101 inputs text data or voice data. When a doctor is observing one or a plurality of image data to be diagnosed, these input data are converted into report information (diagnostic information) 113 representing a diagnostic result about, for example, the symptom of a disease or injury at an anatomical part and output to a diagnostic report output unit 114. In this embodiment, it is unnecessary to explicitly specify the image as a comment target in inputting the data from the report input unit 101. This is because, as will be described later, the correspondence to each observed image is recorded as image link information (to be described later).

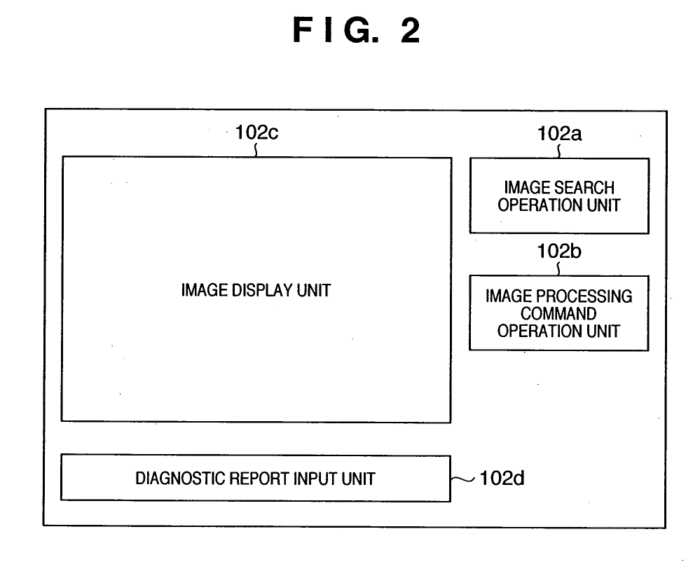

An image operation input unit 102 functions as a user interface to provide, to the user, image search or image processing for each image. FIG. 2 is a schematic view showing the arrangement of the user interface which implements the image operation input unit 102 of the information processing apparatus according to this embodiment. In this embodiment, a doctor operates an image search operation unit 102a to search for and specify images related to a patient to be diagnosed. A list of images corresponding to a patient may automatically be searched for and displayed by inputting the name of the patient or the patient ID.

Referring to FIG. 1, an image search unit 103 searches for an image specified in the image operation input unit 102 from image data (file) stored in an image storage unit 104. More specifically, image data of CT images or X-ray images as medical images about patients are stored in the image storage unit 104. Generally, the image storage unit 104 often exists in another computer connected through a network. Hence, when image data 106 is searched for by the image search unit 103, image link information (link information) 107 such as the PASS (path information) to the image data that is searched for is stored in an image link information recording unit 105.

The image data 106 searched for by the image search unit 103 and read out from the image storage unit 104 is bitmapped on a memory 108. An image processing unit 109 executes image processing designated by the image operation input unit 102 for the image data 106 bitmapped on the memory 108. The processed image data is displayed on an image display unit 110. That is, the image data is displayed on an image display unit 102c in the user interface shown in FIG. 2. Image processing commands include frequency processing, gray level processing, and image rotation/magnification. These commands can be executed by operating buttons arranged in an image processing command operation unit 102b shown in FIG. 2.

The log of image processing operations applied to the image data 106 by the image processing unit 109, (i.e., processing log information 112(image processing information)) containing the type of image processing, parameters (e.g., an image display enlargement/reduction ratio), and image display time is recorded in an image processing/display procedure recording unit 111 in accordance with the operation procedures.

More specifically, as a characteristic feature of the information processing apparatus according to this embodiment, the apparatus further comprises the image processing command operation unit 102b which sets an image processing parameter to cause the image processing unit 109 to execute image processing for image data, the image processing unit 109 executes, for the image data, image processing based on the image processing parameter set by the image processing command operation unit 102b, and the image processing/display procedure recording unit 111 acquires and records the image processing parameter set by the image processing command operation unit 102b as the processing log information 112.

As another characteristic feature, when the image processing command operation unit 102b designates a plurality of image processing parameters, and the image processing unit 109 executes image processing using the image processing parameters in the order of setting of the plurality of image processing parameters, the image processing/display procedure recording unit 111 acquires the image processing parameters as the processing log information 112 in the setting order.

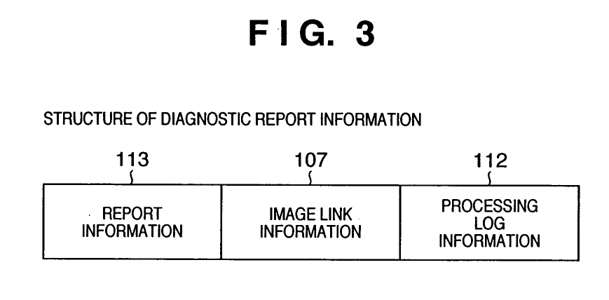

The diagnostic report output unit 114 forms and outputs diagnostic report information in which the report information 113 input by the above-described report input unit 101, the image link information 107 stored in the image link information recording unit 105, and the processing log information 112 stored in the image processing/display procedure recording unit 111 are packaged in one file. FIG. 3 is a view showing the structure of the diagnostic report information formed in this embodiment. In an actual file structure, elements of personal information (e.g., the name and the date of birth) of the patient are sometimes added except the information shown in FIG. 3.

As described above, as a characteristic feature of the information processing apparatus according to this embodiment, the apparatus comprises the image storage unit 104 which stores medical image data, the image search unit 103 which searches the image storage unit 104 for image data, the image processing unit 109 which executes image processing for the image data searched by the image search unit 103, the image display unit 110 which displays the image data which has undergone image processing by the image processing unit 109, the report input unit 101 which inputs the report information 113 related to the image data displayed on the image display unit 110, the image link information recording unit 105 which acquires and records the image link information 107 to the image data stored in the image storage unit 104, the image processing/display procedure recording unit 111 which acquires and records the processing log information 112 for the image data by the image processing unit 109, and the diagnostic report output unit 114 which outputs diagnostic report information containing the image link information 107, processing log information 112, and report information 113.

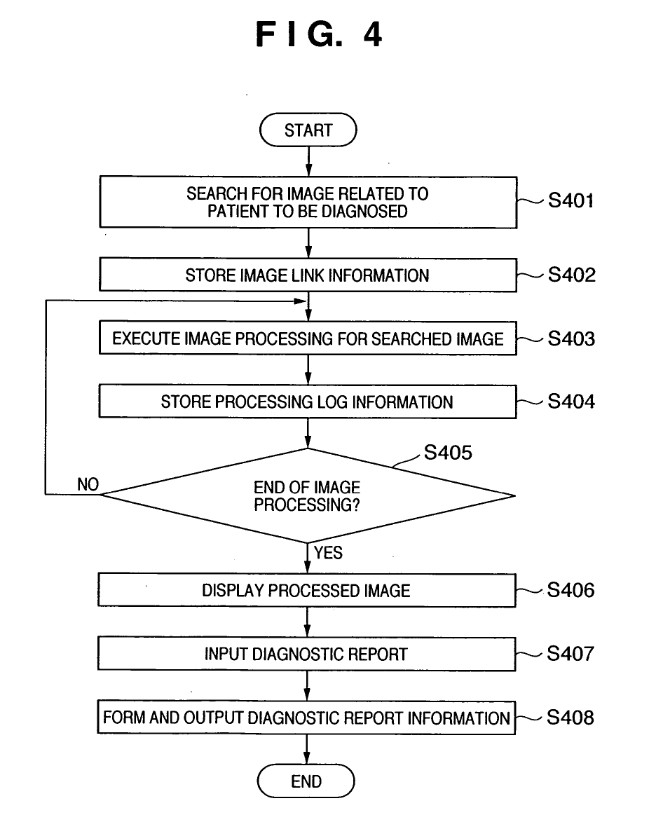

A diagnostic file formation sequence in the information processing apparatus according to this embodiment having the above-described arrangement will be described. FIG. 4 is a flowchart for explaining the diagnostic file formation sequence in the information processing apparatus according to the first embodiment of the present invention.

First, a predetermined operation is performed from the image search operation unit 102a so that the image search unit 103 searches the image storage unit 104 for the image data 106 to be diagnosed (step S401). At this time, the image link information 107 is stored in the image link information recording unit 105 (step S402). The image searched by the image search unit 103 may be displayed at this time on the image display unit 102c.

The image processing unit 109 executes image processing designated from the image processing command operation unit 102b for the searched image data 106 (step S403). At this time, the processing log information 112 about the image processing is stored in the image processing/display procedure recording unit 111 (step S404). The image processed by the image processing unit 109 may be displayed on the image display unit 102c every time. When image processing should further be executed (NO in step S405), the flow returns to the processing in step S403. On the other hand, if image processing is to be ended (YES in step S405), the flow advances to step S406.

In step S406, the processed image is displayed on the image display unit 110 (image display unit 102c). The report information 113 containing text data or voice data is input from the report input unit 101 (step S407). More specifically, the doctor inputs a diagnostic result from a diagnostic report input unit 102d as the report information 113 while observing the image displayed on the image display unit 102c.

The diagnostic report output unit 114 puts the report information 113, processing log information 112, and image link information 107 together to form diagnostic report information and outputs it (step S408).

A case wherein the diagnostic report information created in accordance with the above-described procedures is input and interpreted, and a diagnostic image is played back on the image display unit 102c together with the diagnostic report will be described next.

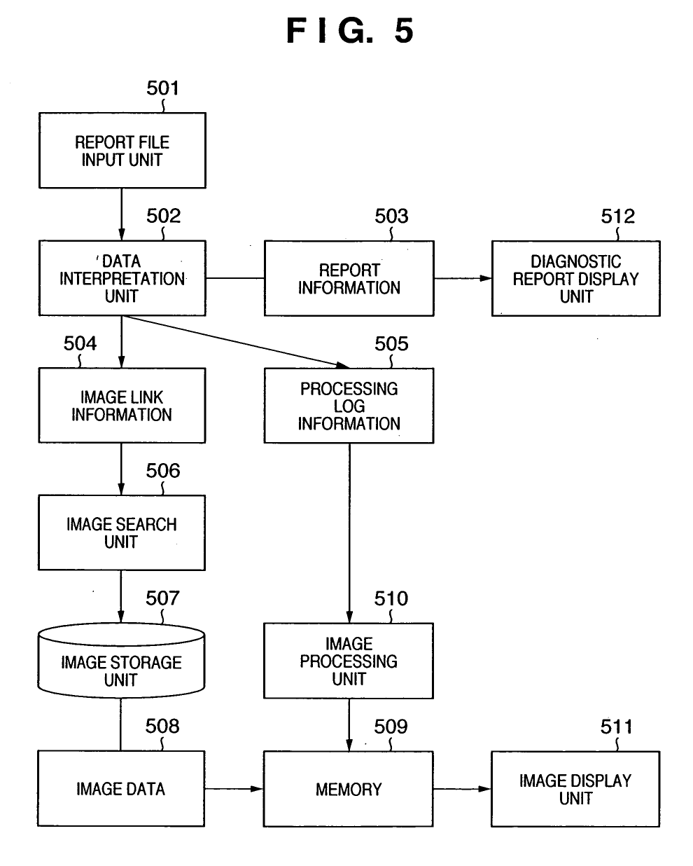

FIG. 5 is a block diagram showing the arrangement of an information processing apparatus (diagnostic report information playback apparatus) to play back an image from the diagnostic report information according to the first embodiment of the present invention. Referring to FIG. 5, a report file input unit 501 inputs diagnostic report information created by using the information processing apparatus shown in FIG. 1. A data interpretation unit 502 parses the diagnostic report information input from the report file input unit 501 into report information 503, image link information 504, and processing log information 505.

An image search unit 506 searches an image storage unit 507 for image data 508 by using the image link information 504. The obtained data is bitmapped on a memory 509. On the basis of the processing log information, an image processing unit 510 executes image processing for the image data 508 bitmapped on the memory 509. An image display unit 511 displays the processed image data. If the image processing procedure indicated by the processing log information 505 is long, the processing may temporarily be stopped at the time when the operator has performed several processing steps. The report information 503 parsed by the data interpretation unit 502 is directly displayed on a diagnostic report display unit 512. In accordance with the above-described procedures, image data and text data are provided to the operator by using the user interface shown in FIG. 2.

More specifically, as a characteristic feature of the diagnostic report information playback apparatus according to this embodiment, the report information 503, image link information 504, and processing log information 505 are extracted from the diagnostic report information created by the above-described information processing apparatus, the image search unit 506 searches the image storage unit 507 for image data on the basis of the extracted image link information 504, the image processing unit 510 executes image processing for the obtained image data on the basis of the processing log information 505, and the image data which has undergone image processing is displayed on the image display unit 511. On the other hand, the report information 503 is displayed on the diagnostic report display unit 512.

As described above, when the information processing apparatus according to this embodiment is used, the situation at the time of image diagnosis can be recorded in the electronic chart. Since the situation is stored in the electronic chart, processed images need not be stored as independent files. When image processing is executed again in accordance with the processing log information, the images actually diagnosed by the doctor can be played back.

More specifically, as a characteristic feature of the information processing apparatus according to this embodiment, images used by a doctor for reading and diagnosis are stored as file names or pointers to the images. In addition, the image processing operation and display time of the used images are added to the diagnostic report and recorded/managed. Clear differences from the conventional system or conventional technique are that link (linking) to an image is done by a file name or a pointer to the image and that information (processing log information) to play back the reading situation such as image processing is added to diagnostic report information.

### Second Embodiment

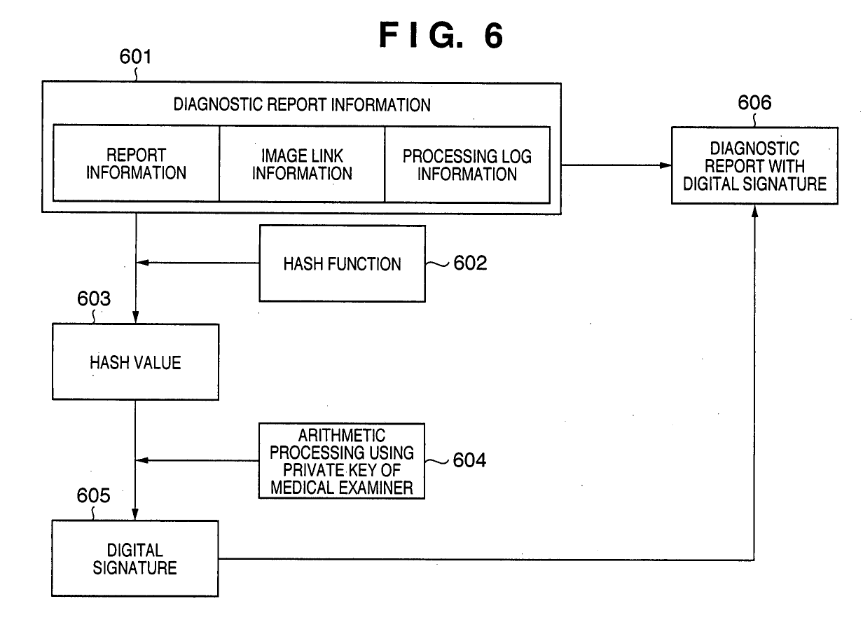

In this embodiment, an information processing apparatus which executes alteration detection processing for a diagnostic report created in the first embodiment will be described. FIG. 6 is a view for explaining a process for adding a digital signature by using the information processing apparatus according to the second embodiment of the present invention. As shown in FIG. 6, diagnostic report information 601 is interpreted as binary data, and a hash function 602 is applied. A hash value 603 as an output is subjected to arithmetic processing 604 by using the private key of a medical examiner to calculate a digital signature 605.

The digital signature 605 is separably added to the diagnostic report information 601 described in the first embodiment (a diagnostic report to which a digital signature is added will be hereinafter referred to as a “diagnostic report with digital signature”). More specifically, as a characteristic feature of the information processing apparatus according to the second embodiment, for the information processing apparatus according to the above-described first embodiment, signature data is created on the basis of a predetermined private key, and the created signature data is added to the diagnostic report information 601.

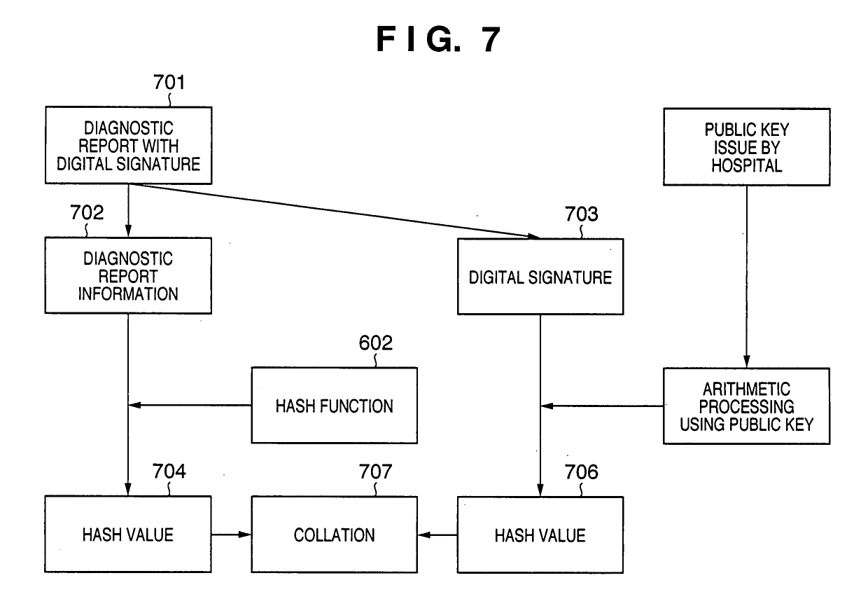

A diagnostic report 606 with digital signature is stored in or transferred to an environment where a risk of alteration is present and referred to. FIG. 7 is a view for explaining a collation process for checking whether alteration has been done in referring to a diagnostic report with digital signature by using the information processing apparatus according to the second embodiment of the present invention.

A diagnostic report 701 with digital signature is parsed into diagnostic report information 702 and a digital signature 703. The same hash function 602 as in FIG. 6 is applied to the diagnostic report information 702 to obtain a hash value 704. The digital signature is subjected to arithmetic processing 705 by using a public key to obtain a hash value 706. Collation 707 between the hash value 704 and the hash value 706 is executed. If the hash values coincide, it is proven that the diagnostic report 701 has not been altered.

As a characteristic feature, the public key used in this case has the nature of a secret key corresponding to individual private keys used by doctors who are in charge of doing diagnosis and creating diagnostic reports in a hospital or clinic where the system is used. Since the public key has the nature of a secret key, for example, the digital signature of a doctor A can be collated by a doctor B by using the public key.

More specifically, as a characteristic feature of the information processing apparatus according to this embodiment, for the above-described information processing apparatus, the digital signature 703 is extracted from the diagnostic report 701 with digital signature, arithmetic processing is executed for the digital signature 703 by using a private key, predetermined arithmetic processing is executed for the diagnostic report information 702, and the arithmetic results are compared to detect alteration in the diagnostic report with digital signature.

As described above, as a characteristic feature of this embodiment, the diagnostic report itself is encrypted/encoded, and additionally, reading diagnostic situation information is also encrypted/encoded in order to prevent any alteration of diagnostic report information and sttictly store medical information.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As described above, according to the present invention, an electronic chart in which link information about a diagnosed medical image, image processing log information, and a diagnostic report are recorded in correspondence with each other can suitably be created.

The present invention is not limited to the above embodiments and various changes and modifications can be made within the spirit and scope of the present invention. Therefore, to apprise the public of the scope of the present invention, the following claims are made.

1. An information processing apparatus comprising:
storage means for storing image data;
search means for searches said storage means for the image data;
image processing means for executing image processing for the image data searched by said search means;
display means for displaying the image data which has undergone image processing by said image processing means;
first acquisition means for acquiring diagnostic information related to the image data displayed by said display means;
second acquisition means for acquiring link information to the image data stored in said storage means;
third acquisition means for acquiring image processing information for the image data by said image processing means; and
output means for outputting diagnostic report information containing the link information, the image processing information, and the diagnostic information.

2. The apparatus according to claim 1, further comprising setting means for setting an image processing parameter to cause said image processing means to execute image processing for the image data,
wherein said image processing means executes, for the image data, image processing based on the image processing parameter set by said setting means, and
said third acquisition means acquires the image processing parameter set by said setting means as image processing information.

3. The apparatus according to claim 2, wherein when said setting means designates a plurality of image processing parameters, and said image processing means executes image processing using the image processing parameters in an order of setting of the plurality of image processing parameters, said third acquisition means acquires the image processing parameters as log information in the setting order.

4. The apparatus according to claim 1, further comprising
extraction means for extracting the diagnostic information, the link information, and the image processing information from the diagnostic report information,
second search means for searching said storage means for image data on the basis of the link information extracted by said extraction means,
second image processing means for executing, on the basis of the image processing information, image processing for the image data searched by said second search means,
second display means for displaying the image data which has undergone image processing,
output means for outputting the diagnostic information.

5. The apparatus according to claim 1, further comprising
signature data creating means for creating signature data on the basis of a predetermined private key, and
signature adding means for adding the signature data to the diagnostic information.

6. The apparatus according to claim 1, further comprising
second extraction means for extracting added signature data from the diagnostic information,
first arithmetic means for executing arithmetic processing for the signature data by using a private key,
second arithmetic means for executing predetermined arithmetic processing for the diagnostic information, and
detection means for detecting alteration in the diagnostic report with the digital signature by comparing a result from said first arithmetic means with a result from said second arithmetic means.

7. An information processing method comprising:
a search step of searching a storage device storing image data for image data;
a first acquisition step of acquiring link information to the image data stored in the storage device;
an image processing step of executing image processing for the image data searched in the search step;
a second acquisition step of acquiring image processing information for the image data in the image processing step;
a display step of displaying the image data which has undergone image processing in the image processing step;
a third acquisition step of acquiring diagnostic information related to the image data displayed in the display step; and
an output step of outputting diagnostic report information containing the link information, the image processing information, and the diagnostic information.

8. A program which causes a computer to execute:
a search procedure for searching a storage device storing image data for image data;
a first acquisition procedure for acquiring link information to the image data stored in the storage device;
an image processing procedure for executing image processing for the image data searched by the search procedure;
a second acquisition procedure for acquiring image processing information for the image data in the image processing procedure;
a display procedure for displaying the image data which has undergone image processing by the image processing procedure;
a third acquisition procedure for acquiring diagnostic information related to the image data displayed by the display procedure; and
an output procedure for outputting diagnostic report information containing the link information, the image processing information, and the diagnostic information.

9. A computer-readable recording medium comprising a program of claim 8.
